(19) United States
(12) Patent Application Publication
(10) Pub. No.: US 2016/0230443 A1
(43) Pub. Date: Aug. 11, 2016

(54) Surface Mountable Security Asset Storage Container

(71) Applicant: Key Systems, Inc., Fishers, NY (US)

(72) Inventors: George Mastrodonato, Rochester, NY (US); George H. Eckerdt, Victor, NY (US)

(21) Appl. No.: 15/040,450

(22) Filed: Feb. 10, 2016

Related U.S. Application Data
(60) Provisional application No. 62/115,113, filed on Feb. 11, 2015.

(51) Int. Cl. E05G 1/026

(52) U.S. Cl. CPC E05G 1/026

(57) ABSTRACT

A container includes a web server that can communicate with a web browser to control access and account for asset events that occur when the box is used. A personal identifier must be satisfied to open a drawer of the box. A latching system uses an access actuator for normal opening and closing in response to the personal identifier. Several features secure the box against weather and tampering.

### BACKGROUND

The present invention relates to controlled access to security assets in storage containers.

A security asset storage container or security box containing a security asset, such as a key, should be secure. It should not easily yield to forced entry, and it should reliably open only to authorized people. A security box should also be readily adaptable to many different locations and mounting arrangements. These often include, but are not limited to, walls structured in various ways. Security boxes should also be weather resistant so that they can be mounted in outdoor locations. As these requirements suggest, security boxes can be made in many different sizes and shapes that can be characterized as enclosures, containers, safes, compartments, etc. This application uses “box” as a simple term covering all of these possibilities.

### SUMMARY

An embodiment of the invention disclosed herein can take the form of a security box including an openable closure and an access actuator that can obstruct movement of the closure from a closed position to an open position. Circuitry can be included that can operate the actuator. An input device can be in communication with the circuitry to allow entry of a personal identifier, responsive to which the circuitry can operate the actuator. Embodiments can include a push-to-release feature in which the closure is biased toward the open position so that the actuator is prevented from releasing the closure until the closure is pushed into a housing of the box into a release position.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is an elevation view of a security asset storage container according to embodiments of the invention disclosed herein.

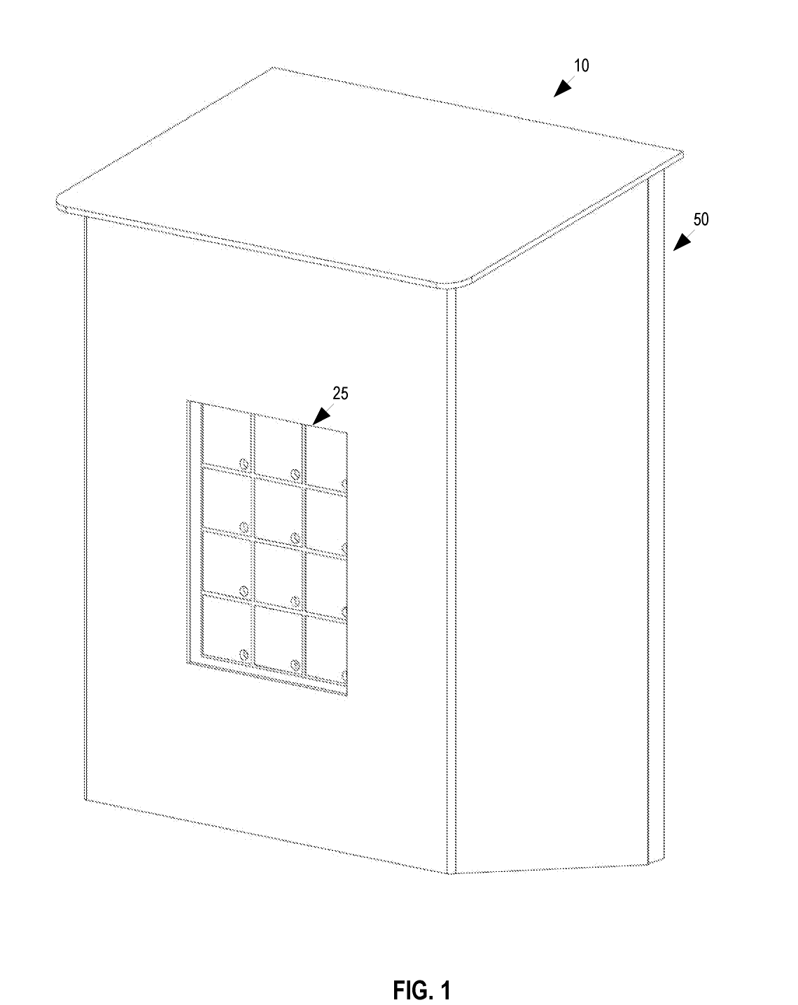

FIG. 2 is an elevation view of the container of FIG. 1 with a drawer portion of the container open according to embodiments of the invention disclosed herein.

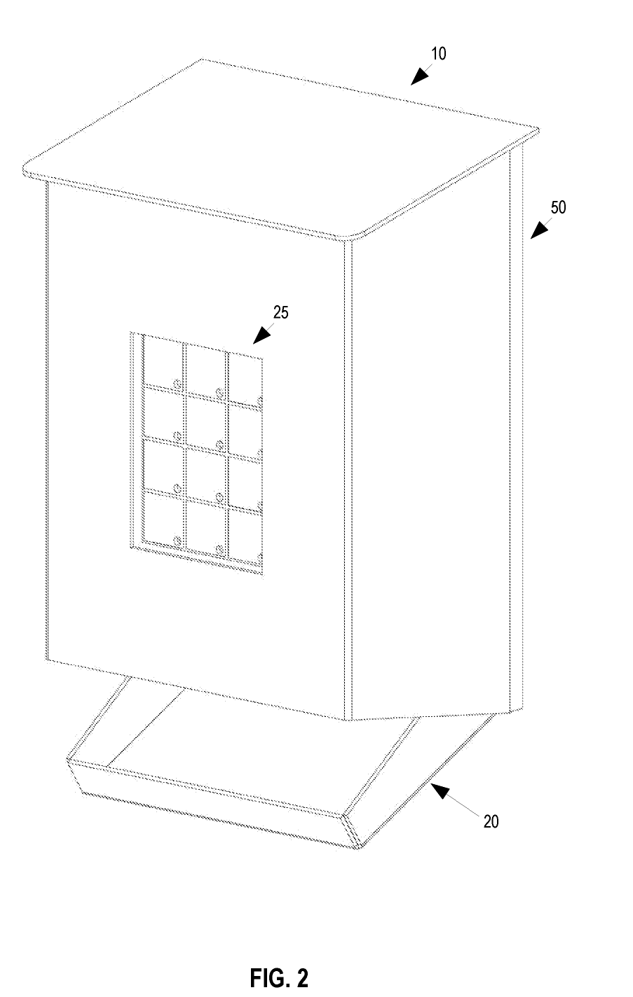

FIG. 3 is a front view of the container shown in FIGS. 1 and 2.

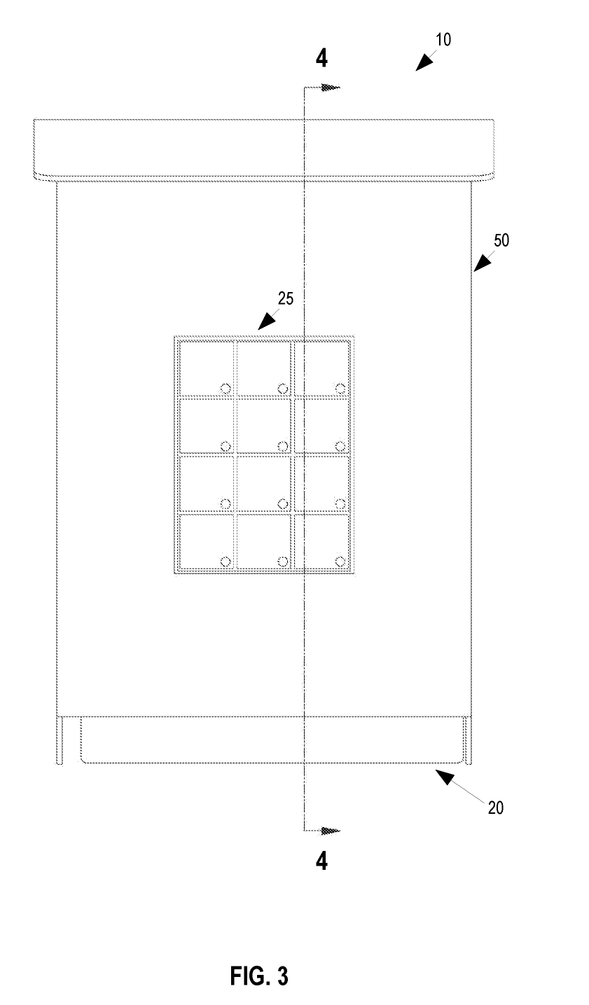

FIG. 4 is a cross-sectional view of the container of FIGS. 1-3 taken along the line 4-4 in FIG. 3.

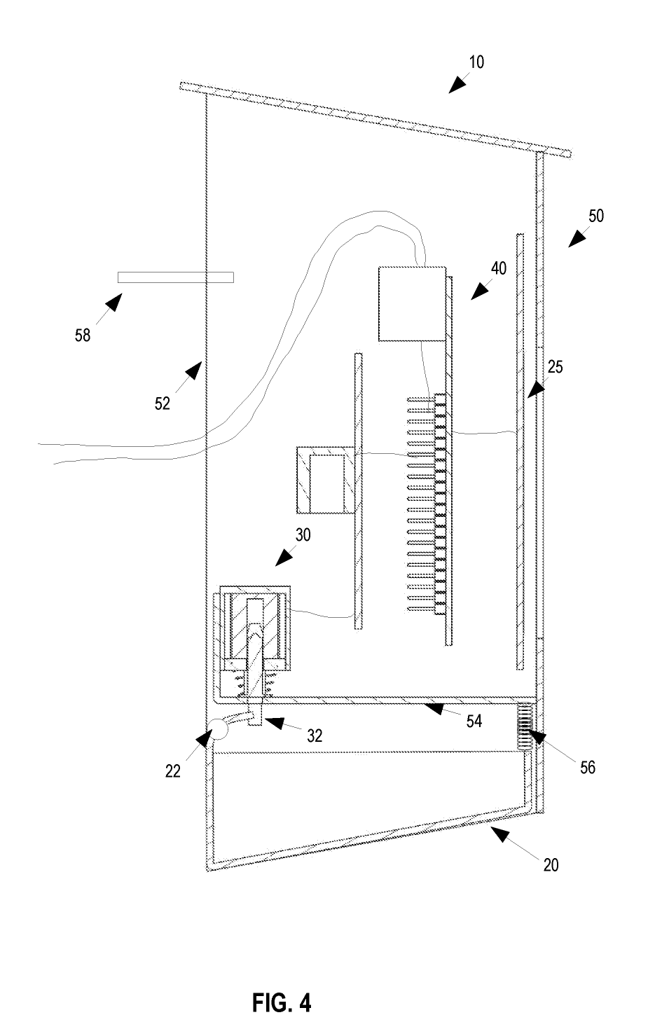

FIG. 5 is a cross-sectional view of the container of FIGS. 1-3 taken along line 4-4 of FIG. 3 and showing an alternate actuator according to embodiments of the invention disclosed herein.

### DETAILED DESCRIPTION

The security asset storage container or security box 10 as illustrated can be mounted on a surface, such as a wall, and can use an openable closure 20, such as a drawer, door, or lid, that can open from a housing 50 to afford access to a security asset. In some respects, box 10 can resemble an upside-down mailbox, though this need not be the configuration employed in embodiments. In the example shown, closure 20 is shown as a drawer, which can be convenient for several reasons as a way of accessing contents of box 10. Closure 20 can hold a security asset, such as a key, though things other than keys can also be secured within box 10. For example, other types of security assets can include smart cards, special tools, or anything of security importance that can fit within box 10 and for which one is willing to go to the expense of controlled access.

Access to box 10 can be controlled by a personal identifier so that only authorized persons can gain access to box 10. One simple way that this can be done is with number pad 25 that can be conveniently arranged on a front face of box 10. Biometric devices such as thumb or fingerprint readers, eye image readers, and possibly others, can also be used so long as such a device can restrict access to box 10 to only the person or people who are authorized.

Box 10 can use an access actuator 30, such as a solenoid as shown in the FIGS., arranged in a housing 50 of box 10 or in closure 20 to unlatch closure 20 for opening in response to entry of an authorized personal identifier. Actuator 30 can obstruct motion of closure 20, such as by maintaining the pin of a solenoid in a path of closure 20 as shown. Actuator 30 can be controlled by circuitry 40 responsive to pad 25 and powered by a power supply (not shown), such as a battery or power over Ethernet (PoE). A suitable hole can be formed in housing 50, such as in a back wall 52, to allow passage of an Ethernet cable into box 10 for connection to circuitry 40, which can include a suitable connector. Circuitry 40 can include a web server 60 to allow remote control and/or monitoring and/or any other suitable communication with box 10.

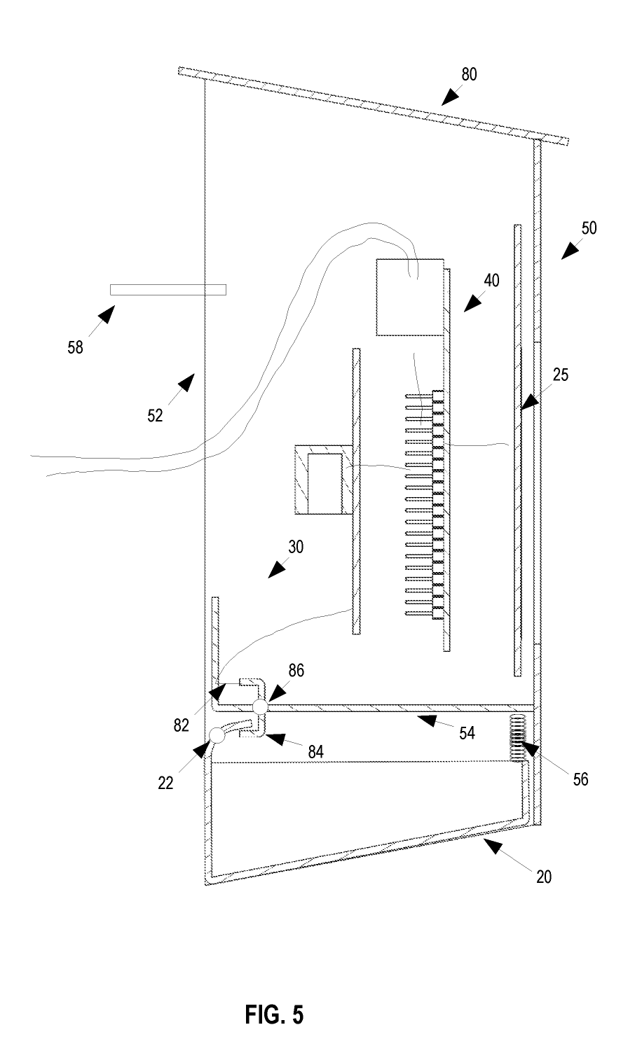

The closed position is illustrated in FIG. 5 with actuator 30 mounted on a wall 54 inside housing 50. Here actuator 30 is shown in the form of a solenoid with a pin 32 blocking motion of closure 20 toward an open position. When solenoid 30 is energized, its pin is biased out of obstructing closure 20. In embodiments, the force exerted by solenoid 30 is inadequate to overcome friction between closure 20 and pin 32 unless closure 20 is pushed slightly into housing 50 into a release position. Once closure 20 is in the release position, pin 32 can retract into solenoid 30, allowing closure 20 to open, such as by pivoting around a hinge 22 or other pivot arrangement. Closure 20 can be shaped to engage an end of pin 32 while open so as to hold pin 32 out of the way. When closure 20 is returned to the closed position, pin 32 can return to its obstruction of motion of closure 20 toward the open position.

To enable this push-to-release feature, one or more springs 56 can be arranged in housing 50 to bias closure 20 toward the open position. When access solenoid 30 is actuated, the force of springs 56 pushing on closure 20 frictionally holds pin 32 of solenoid 30 in place. Pushing closure 20 into housing 50 overcomes the spring bias and allows solenoid pin 32 to release which then allows drawer 20 to move under the urging of springs 56 and/or of gravity.

Securing housing 50 to a wall or other surface can be done in several ways. One way is to place an adhesive material on the surface onto which back wall 52 of housing 50 is pressed so that adhesive can strongly resist any removal of housing 50. Another way is to use bolts or the like passed through back wall 52, screws into back wall 52, or other suitable attachment devices or fasteners 58, which can also be used in combination with adhesive if suitable and/or desired. Many other arrangements of fasteners, set screws, adhesives, welding, and other expedients can be used to secure housing 50 solidly in place.

Another embodiment of a security box 80 is shown in FIG. 8, and is similar to box 10 except for a different latching arrangement. Access actuator 30 here takes the form of a wire 82 that shrinks when energized by circuitry 40 to bias an obstructing flange 84 out of engagement with closure 20. In the example shown, flange 84 pivots about a hinge 86 or other suitable pivot and is shaped to bear any load exerted by closure 20, thus protecting wire 82 from overstress and/or breakage. As with box 10, springs 54 bias closure 20 toward the open position so that obstructing flange 84 is restrained against releasing closure 20 until closure 20 is pushed into housing 50 into the release position. Once closure 20 is in the release position, wire 82 moves flange 84 out of the way and closure 20 can move to the open position. Closure 20 can hold flange 84 out of the way until returned to the closed position, at which point flange 84 can drop back into the path of closure 20 to prevent opening of closure 20.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A security box comprising:
a housing pivotably supporting an openable closure of the box, the closure having a closed position and an open position; and
an access actuator arranged to obstruct movement of the closure from the closed position to the open position.

2. The security box of claim 1, further comprising:
an input device accessible from an exterior of the box;
circuitry mounted in the housing and in communication with the access actuator and the input device that operates the access actuator to allow opening of the closure to gain access to an interior of the box responsive to entry of a personal identifier with the input device.

3. The security box of claim 1, further comprising a flange pivotably mounted in the housing so as to obstruct movement of the closure from the closed position to the open position.
